(19) United States
(12) Patent Application Publication
(10) Pub. No.: US 2018/0127557 A1
(43) Pub. Date: May 10, 2018

(54) WATER-BASED SEALING COMPOSITIONS WITH AMINOSILANE CROSSLINKERS

(71) Applicant: Saudi Arabian Oil Company, Dhahran (SA)

(72) Inventors: B. Raghava REDDY, Pearland, TX (US); Matthew Gary HILFIGER, Richmond, TX (US)

(21) Appl. No.: 15/800,933

(22) Filed: Nov. 1, 2017

Related U.S. Application Data
(60) Provisional application No. 62/417,773, filed on Nov. 4, 2016.

(51) Int. Cl. C08J 3/24; C08F 22/06; C09K 8/512; E21B 33/138

(52) U.S. Cl. CPC C08J 3/24; C08F 22/06; C08J 2335/00; E21B 33/138; C09K 8/512

(57) ABSTRACT

Treating a subterranean formation with a composition including a maleic anhydride copolymer and an aminosilane crosslinker. The maleic anhydride copolymer includes first repeat units I and II and at least one of second repeat units III and IV:

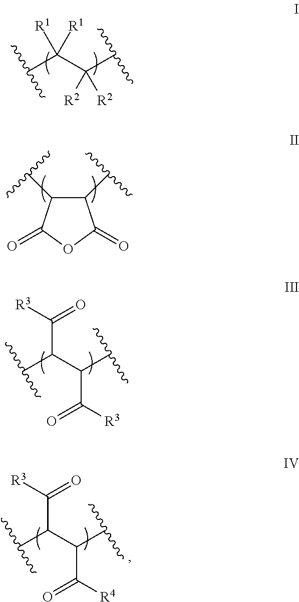

where each R¹ is independently —H, —O(C₁-C₅) alkyl, or —(C₁-C₅) alkyl; each R² is independently —H, —O(C₁-C₅) alkyl, or —(C₁-C₅) alkyl; each R³ is independently —OH or —O⁻M¹, each M¹ is independently an alkali metal, an alkaline earth metal, an ammonium ion, or a quaternary ammonium ion; and each R⁴ is independently —NH₂ or —OM¹. The aminosilane crosslinker has at least one primary amine group. Siloxane bonds may be formed between the aminosilane crosslinker and a siliceous material in contact with the gelled composition in the subterranean formation.

### CROSS-REFERENCE TO RELATED APPLICATION

This application claims the benefit of U.S. Patent Application Ser. No. 62/417,773 entitled “WATER-BASED SEALING COMPOSITIONS WITH AMINOSILANE CROSSLINKERS” and filed Nov. 4, 2016, which is incorporated by reference herein in its entirety.

### TECHNICAL FIELD

This document relates to water-based sealing compositions with an aminosilane crosslinker, and more particularly to water-based sealing compositions including a maleic anhydride/alkene copolymer and an aminosilane crosslinker.

### BACKGROUND

Water-based resin systems including maleic anhydride copolymers crosslinked with amine crosslinkers have been used to seal off flow channels in subterranean formations. The amine crosslinkers are typically polyamine crosslinkers, having at least two primary amine groups. While the polyamine crosslinkers effectively crosslink the maleic anhydride copolymers, improved sealing of flow channels in certain materials, such as set cement, would be beneficial.

### SUMMARY

In a first general aspect, a composition for treating a subterranean formation includes a maleic anhydride copolymer and an aminosilane crosslinker having at least one primary amine group. The maleic anhydride copolymer includes first repeat units I and II and at least one of second repeat units III and IV, as shown below:

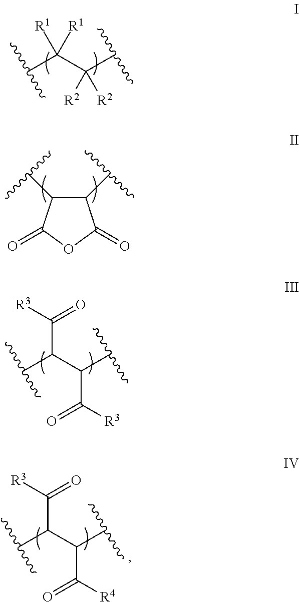

where each R¹ is independently selected from the group consisting of —H, —O(C₁-C₅) alkyl, and —(C₁-C₅) alkyl; each R² is independently selected from the group consisting of —H, —O(C₁-C₅) alkyl, and —(C₁-C₅) alkyl; each R³ is independently selected from the group consisting of —OH and —O⁻M¹, each M¹ is independently selected from the group consisting of an alkali metal, an alkaline earth metal, an ammonium ion, and a quaternary ammonium ion; and each R⁴ is independently selected from the group consisting of —NH₂ and —OM¹.

In a second general aspect, treating a subterranean formation includes providing to the subterranean formation a composition of the first general aspect, and crosslinking the maleic anhydride copolymer of the composition with the aminosilane crosslinker of the composition to form a sealant.

Implementations of the first and second general aspects may include one or more of the following features.

Second repeat units III and IV may include repeat unit IIIA and repeat unit IVA, respectively:

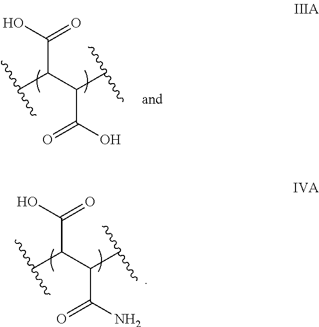

In some embodiments, the aminosilane crosslinker is an aminoalkoxysilane, such as an aminotrialkoxysilane. In certain embodiments, the aminosilane crosslinker has 0, 1, or 2 secondary amine groups. In some examples, the aminosilane crosslinker is 3-aminopropyl-triethoxysilane, 2-aminoethyl-3-aminopropyltrimethoxysilane, or N¹-(3-trimethoxysilylpropyl)-diethylenetriamine. The aminosilane crosslinker is typically 0.5% to 10% by weight of the composition.

The composition may include a polyamine crosslinker having at least two primary amine groups.

In some cases, the composition includes a gelling agent. The gelling agent may include at least one of a calcium chelating agent, a calcium precipitating agent, a pH buffer, an agent reactive with hydroxide, and an acid generating agent. The gelling agent promotes formation of a gel comprising the maleic anhydride copolymer and the aminosilane crosslinker in contact with set cement.

In certain cases, the composition includes a gel time control agent. The gel time control agent includes at least one of: a salt that yields a basic solution when dissolved in water; a salt that yields an acidic solution when dissolved in water; an uncharged organic molecule that yields a basic solution when dissolved in water; an uncharged organic molecule that yields an acidic solution when dissolved in water; and a pH buffer. The gel time control agent accelerates or retards formation of a gel comprising the maleic anhydride copolymer and the aminosilane crosslinker in the absence of set cement.

Implementations of the second general aspect may include one or more of the following features.

In some cases, crosslinking the maleic anhydride copolymer with the aminosilane crosslinker to form the sealant occurs near a casing, a casing-casing annulus, a tubing-casing annulus, or a casing-formation annulus. Crosslinking the maleic anhydride copolymer with the aminosilane crosslinker may occur in a crack or microannulus of a pipe. In certain cases, crosslinking the maleic anhydride copolymer with the aminosilane crosslinker to form the sealant prevents or retards undesired loss or flow of wellbore fluid into the formation or of formation fluids into the wellbore.

Treating a subterranean formation with the composition may include forming siloxane bonds between the aminosilane crosslinker and a siliceous material in contact with the composition.

In some embodiments, the composition includes a gel time control agent, and crosslinking the maleic anhydride copolymer with the aminosilane crosslinker to form the sealant occurs in the absence of set cement. In certain embodiments, the composition includes a gelling agent, and crosslinking the maleic anhydride copolymer with the aminosilane crosslinker to form the sealant occurs in the presence of set cement.

The details of one or more implementations of the subject matter described in this specification are set forth in the description below. Other features, aspects, and advantages of the subject matter will become apparent from the description and the claims.

### BRIEF DESCRIPTION OF THE DRAWINGS

FIG. 1 shows a plot of viscosity versus time for gel formation of Product A.

FIG. 2 shows a plot of viscosity versus time for gel formation of Product C.

FIG. 3 shows a plot of viscosity versus time for gel formation of Product D.

FIG. 4 shows a plot of viscosity versus time for gel formation of Product E.

FIG. 5 shows a plot of viscosity versus time for gel formation of Product F.

FIG. 6 shows a plot of viscosity versus time for gel formation of Product H.

FIG. 7 shows a plot of viscosity versus time for gel formation of Product J.

FIG. 8 shows a plot of viscosity versus time for gel formation of Product K.

FIG. 9 shows a plot of viscosity versus time for gel formation of Product L.

FIG. 10 shows a plot of viscosity versus time for gel formation of Product M.

### DETAILED DESCRIPTION

A composition for sealing off flow channels includes a maleic anhydride copolymer and an aminosilane crosslinker. As used herein, “maleic anhydride copolymer” generally refers to a maleic anhydride/alkene copolymer or a salt thereof. The aminosilane crosslinker may be an aminoalkoxysilane crosslinker. In some examples, the aminosilane crosslinker includes a single primary amine. In some examples, the aminosilane crosslinker includes more than one primary amine. In certain examples, the aminosilane crosslinker is an aminotrialkoxysilane with a single primary amine group. The aminosilane crosslinker crosslinks the maleic anhydride copolymer and also binds with formation rock and cement particles via siloxane bonds, thereby improving sealant properties of the composition. The composition may also include a polyamine crosslinker having at least two primary amine groups, a gelling agent to promote gel formation in the presence of set cement, a gel time control agent to accelerate or decelerate gel formation, or any combination thereof.

The maleic anhydride copolymer includes first repeat units I and II:

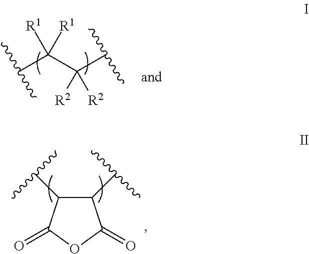

where each R¹ is independently selected from the group consisting of —H, —O(C₁-C₅) alkyl, and —(C₁-C₅) alkyl. Each R² is independently selected from the group consisting of —H, —O(C₁-C₅) alkyl, and —(C₁-C₅) alkyl. The maleic anhydride copolymer further includes at least one second repeat unit selected from the group consisting of repeat units III and IV:

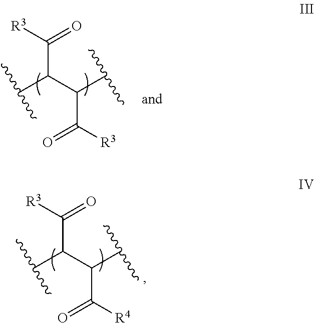

where each R³ is independently selected from the group consisting of —OH and —O⁻M¹, each M¹ is independently selected from the group consisting of an alkali metal, an alkaline earth metal, an ammonium ion, and a quaternary ammonium ion, and each R⁴ is independently selected from the group consisting of —NH₂ and —OM¹. In some embodiments, M¹ is selected from the group consisting of Na⁺, K⁺, Mg²⁺, NH₄⁺, Ca²⁺ and Ba²⁺. For example, M¹ can be selected from the group consisting of Na⁺ and K⁺. When at least one R³ in repeat unit III or IV is —OH, the repeat unit is referred to as a “hydrolyzed” repeat unit, formed, for example, by reaction of its nonhydrolyzed counterpart with water. When at least one R³ in repeat unit III or IV is —O⁻M¹ where M¹ is NH₄⁺, the repeat unit is referred to as an “ammonolyzed” repeat unit, formed, for example, by reaction of its nonammonolyzed counterpart with ammonium hydroxide.

In some embodiments, each R³ is —OH and R⁴ is —NH₂, such that repeat units III and IV are represented as repeat units IIIA and IVA, respectively, as shown below:

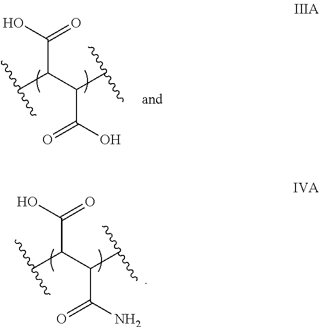

The composition can also include reaction products of the maleic anhydride copolymer and the aminosilane crosslinker.

In some embodiments, the at least one second repeat unit includes repeat unit III. In some embodiments, the ratio of repeat unit III to repeat unit II is about 1:10 to about 10:1. For example, the ratio of repeat unit III to repeat unit II can be about 8:1 to about 1:8, about 6:1 to about 1:6, about 4:1 to about 1:4, about 2:1 to about 1:2, or about 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, or 1:10. In some embodiments, the ratio of repeat unit III to repeat unit II is about 1:2. In some embodiments, the ratio of repeat unit III to repeat unit II is about 2:1.

In some embodiments, the at least one second repeat unit includes repeat unit IV. In some embodiments, the ratio of repeat unit IV to repeat unit II is about 1:10 to about 10:1. For example, the ratio of repeat unit IV to repeat unit II can be about 8:1 to about 1:8, about 6:1 to about 1:6, about 4:1 to about 1:4, about 2:1 to about 1:2, or about 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, or 1:10. In some embodiments, the ratio of repeat unit IV to repeat unit II is about 1:2.

In some embodiments, the second repeat unit includes repeat units III and IV. The ratio of repeat unit III to repeat unit IV can be about 1:10 to about 10:1, and the ratio of repeat unit IV to repeat unit II can be about 1:10 to about 10:1. For example, the ratio of repeat unit III to repeat unit IV can be about 8:1 to about 1:8, about 6:1 to about 1:6, about 4:1 to about 1:4, about 2:1 to about 1:2, or about 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, or 1:10, and the ratio of repeat unit IV to repeat unit II can be about 8:1 to about 1:8, about 6:1 to about 1:6, about 4:1 to about 1:4, about 2:1 to about 1:2, or about 10:1, 9:1, 8:1, 7:1, 6:1, 5:1, 4:1, 3:1, 2:1, 1:1, 1:2, 1:3, 1:4, 1:5, 1:6, 1:7, 1:8, 1:9, or 1:10.

In some embodiments, each R′ is independently selected from the group consisting of —H, —OCH₃, and —CH₃ and each R² is independently selected from the group consisting of —H, —OCH₃, and —CH₃. For example, R¹ can be H, and each R² can be independently selected from the group consisting of —H, —OCH₃, and —CH₃.

In some embodiments, repeat unit I is selected from the group consisting of:

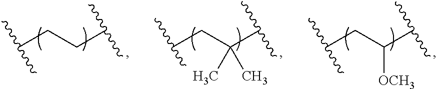

and combinations thereof.
For example, repeat unit I can have the structure:

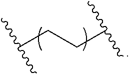

In some embodiments, repeat unit I has the structure:

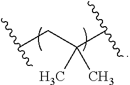

In some embodiments, the maleic anhydride copolymer has a weight-average molecular weight of about 10,000 Da to about 500,000 Da. For example, the maleic anhydride copolymer can have a weight-average molecular weight of about 10,000-100,000 Da, about 20,000-90,000 Da, about 30,000-70,000 Da, about 40,000-60,000 Da, or a weight-average molecular weight of about 45,000-55,000 Da or a weight-average molecular weight of about 10,000 Da, 20,000 Da, 30,000 Da, 40,000 Da, 50,000 Da, 60,000 Da, 70,000 Da, 80,000 Da, 90,000 Da or about 100,000 Da. The maleic anhydride copolymer can have a weight-average molecular weight of about 100,000-500,000 Da, about 200,000-400,000 Da, about 250,000-350,000 Da or a weight-average molecular weight of about 100,000 Da, 150,000 Da, 200,000 Da, 250,000 Da, 300,000 Da, 350,000 Da, 400,000 Da, 450,000 Da or about 500,000 Da.

In some embodiments, the maleic anhydride copolymer has a number-average molecular weight of about 10,000 Da to about 500,000 Da. For example, the maleic anhydride copolymer can have a number-average molecular weight of about 10,000-100,000 Da, about 20,000-90,000 Da, about 30,000-70,000 Da, about 40,000-60,000 Da, or a number-average molecular weight of about 45,000-55,000 Da or a number-average molecular weight of about 10,000 Da, 20,000 Da, 30,000 Da, 40,000 Da, 50,000 Da, 60,000 Da, 70,000 Da, 80,000 Da, 90,000 Da or about 100,000 Da. The maleic anhydride copolymer can have a number-average molecular weight of about 100,000-500,000 Da, about 200,000-400,000 Da, about 250,000-350,000 Da or a number-average molecular weight of about 100,000 Da, 150,000 Da, 200,000 Da, 250,000 Da, 300,000 Da, 350,000 Da, 400,000 Da, 450,000 Da or about 500,000 Da.

In some embodiments, the distribution of first repeat units I and II can be alternating, random or in blocks, in which case the resulting copolymers are referred to as alternating, random or block copolymers, respectively. In an embodiment, the copolymer is an alternating copolymer, with alternating repeat units I and II.

Examples of suitable maleic anhydride copolymers include ISOBAM® polymers from Kuraray Co., Ltd. (Tokyo, Japan), ethylene-maleic anhydride copolymers and propylene-maleic anhydride copolymers from Honeywell Corporation (USA), and ZEMAC® copolymers from Vertellus (Spain).

Suitable aminosilane crosslinkers include aminosilanes having at least a single primary amine group, such as aminoalkyl alkoxysilanes, and aminoalkylaminoalkyl alkoxysilanes. Examples of suitable aminoalkyl alkoxysilanes include aminoalkyl trialkoxysilanes, such as 3-aminopropyltriethoxy-silane, and aminoalkylaminoalkyl alkoxysilanes such as 2-aminoethyl-3-aminopropyl-trimethoxysilane, and N′-(3-trimethoxysilylpropyl)-diethylenetriamine, depicted below.

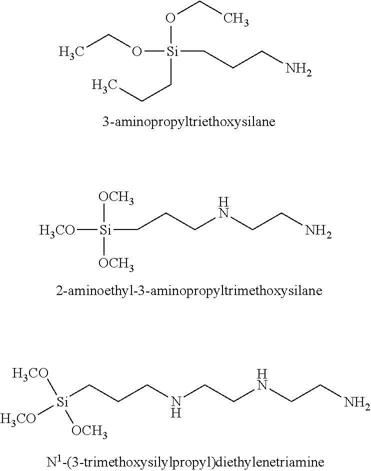 [SMILES: CCC[Si](CCCN)(OCC)OCC ; CO[Si](CCCNCCN)(OC)OC ; CO[Si](CCCNCCNCCN)(OC)OC]

Suitable aminosilane crosslinkers also include aminosilanes containing more than one primary amine. In some embodiments, the aminosilane is employed in neat form, where “neat” refers to a compound in its pure state. In some embodiments, the aminosilane is employed as a solution in an organic solvent. In preferred embodiments, the organic solvent is water miscible. A suitable organic solvent is a water-miscible alcohol. In an embodiment, the water-miscible alcohol corresponds to the alkoxy moieties present in the aminosilane. For example, a trimethoxyaminosilane can be employed as a methanol solution, and a triethoxyaminosilane can be employed as an ethanol solution.

In some embodiments, the ratio of the maleic anhydride copolymer to the aminosilane crosslinker is about 50:1 to about 1:1. For example, the weight ratio of the crosslinkable polymer to the aminosilane crosslinker can be about 40:1 to about 1:1, about 30:1 to about 1:1, about 20:1 to about 1:1, about 15:1 to about 1:1, about 10:1 to about 1:1, about 9:1 to about 1:1, about 7:1 to about 1:1, about 5:1 to about 1:1, about 4:1 to about 1:1, about 3:1 to about 1:1, or about 2:1 to about 1:1, or about, 50:1, 40:1, 30:1, 20:1, 15:1, 10:1, 9:1, 8:1, 7:1, 6:1, 5:1, 4:1, 3:1, 2:1, 1:1. The ratio of the maleic anhydride copolymer to the aminosilane crosslinker can be varied based on the desired properties of the crosslinked product to be formed, such as the desired gel time and the type of subterranean formation in which the flow channel occurs. In one example, the ratio of aminosilane crosslinker to maleic anhydride copolymer is greater when the flow channel to be sealed occurs in cement or formation rock, thereby enhancing formation of siloxane bonds with the cement or the formation rock.

In some embodiments, the composition includes a polyamine crosslinker in addition to the aminosilane crosslinker. The polyamine crosslinker includes at least two primary amine groups.

The polyamine crosslinker may include at least one of a polyalkyleneimine, polyetheramine, polyalkylenepolyamine, aliphatic amine, polyfunctional aliphatic amine, arylalkylamine, heteroarylalkylamine, chitosan. For example, the polyamine crosslinker can include at least one of polyethyleneimine, ethylenediamine, diethylenetriamine (DETA), triethylenetriamine (TETA), tetraethylenepentamine (TEPA), 1,2-propylenediamine, 1,3-propylenediamine, dipropylenetriamine, tripropylenetetramine, tetrapropylenepentamine, ethylene propylene triamine, ethylene dipropylene tetramine, diethylene propylene pentamine, ethylene tripropylene pentamine, diethylene dipropylene pentamine, triethylene propylene pentamine, polyethylenimine (e.g., EPOMIN® from Nippon Shokubai, LUPASOL™ from BASF, LUPAMINE™ from BASF, etc.) poly(ethyleneoxy)amine (e.g., JEFFAMINE® EDR-148 from Huntsman Corporation), and poly(propyleneoxy)amine (e.g., JEFFAMINE® T-403 from Huntsman Corporation, Polyetheramine T-5000 from BASF). Additionally, the polyamine crosslinker can be selected from the group consisting of polyethyleneimine, poly(ethyleneoxy)amine, and TEPA. In some embodiments, the polyamine crosslinker is a polyetheramine. In some embodiments, the polyamine crosslinker is an aliphatic amine.

In some embodiments, the polyethyleneimine has a weight-average molecular weight of about 500 Da to about 1,000,000 Da. In some embodiments, the polyethyleneimine has a weight-average molecular weight of about 1,000-1,000,000. For example, the polyethyleneimine can have a weight-average molecular weight of about 1,000-5,000, 5,000-10,000, 10,000-50,000, 50,000-150,000, 150,000-500,000 or about 500,000 to about 1,000,000 or about 1,000, 2,000, 3,000, 4,000, 5,000, 10,000, 25,000, 50,000, 100,000, 250,000, 500,000, 750,000 or about 1,000,000. In some embodiments, the polyethyleneimine has a weight-average molecular weight of about 1,800 Da.

In some embodiments, the ratio of the maleic anhydride copolymer to the polyamine crosslinker is about 100:1 to about 1:1. For example, the weight ratio of the crosslinkable polymer to the polyamine crosslinker can be about 90:1 to about 1:1, about 70:1 to about 1:1, about 50:1 to about 1:1, about 30:1 to about 1:1, about 10:1 to about 1:1, about 9:1 to about 1:1, about 7:1 to about 1:1, about 5:1 to about 1:1, about 4:1 to about 1:1, about 3:1 to about 1:1, or about 2:1 to about 1:1, or about, 80:1, 60:1, 40:1, 20:1, 15:1, 10:1, 9:1, 8:1, 7:1, 6:1, 5:1, 4:1, 3:1, 2:1, 1:1. The ratio of the maleic anhydride copolymer to the polyamine crosslinker can be varied based on the desired properties of the crosslinked product to be formed, such as the desired gel time and gel stiffness. In some embodiments, the aminosilane crosslinker is 0.5% to 10%, 0.5% to 5%, or 0.5% to 3% by weight of the composition.

In some embodiments, the composition includes a gelling agent selected to promote gel formation of the composition in contact with set cement. The gelling agent reduces interference of the set cement with crosslinking reactions in the composition, and thus promotes formation of a gel in contact with set cement. The gelling agent may include a calcium chelating agent, a calcium precipitating agent, a pH buffer, an agent reactive with hydroxide, or acid generating agent. “Acid generating agent” generally refers to monomeric and polymeric compounds which, upon reaction with water, generate an organic or inorganic acid. Suitable examples of acid generating agents include organic esters such as ethyl acetate, triethyl citrate, and diethyl tartrate; acid chlorides such as benzoyl chloride; and acid anhydrides such as succinic anhydride, lactide, and acetic anhydride. An acid generating agent may be polymeric. Suitable polymeric acid generating agents include polylactic acid and polyglycolic acid.

In some embodiments, the gelling agent is a salt formed by a reaction between a weak acid and a base. The base may be strong or weak, organic or inorganic. In other embodiments, the gelling agent is a buffer solution formed from a weak organic acid and a weak organic base. Examples of such gelling agents include sodium hexametaphosphate, sodium tetraborate (synthetic or mineral borax), disodium hydrogen phosphate, sodium carbonate, sodium phosphate, the pentasodium salt of amino tris(methylene phosphonic acid), and a buffer solution of ethanolamine and citric acid. The gelling agent can be about 0.5% to about 10% of the composition by weight. In some cases, the gelling agent is about 0.5% to about 2.5% of the composition by weight. In an embodiment, the composition of pH buffer maintains the pH of the resin composition at any value in the range 3 to 10.

In some embodiments, the composition includes a gel time control agent selected to accelerate or retard gelling of a composition for sealing off flow channels in the absence of set cement. Suitable gel time control agents include salts that yield a basic solution when dissolved in water, salts that yield an acidic solution when dissolved in water, uncharged organic molecules that yield a basic solution when dissolved in water, uncharged organic molecules that yield an acidic solution when dissolved in water, and pH buffers. Salts and uncharged organic molecules that yield a basic solution when dissolved in water, such as sodium hexametaphosphate, sodium bicarbonate, sodium carbonate, sodium tetraborate, sodium phosphate (Na₃PO₄), monoethanolamine, triethanolamine, and N,N-dimethyl ethylene diamine, can extend the gel time (retard gelling) of the composition. Salts and uncharged organic molecules that yield an acidic solution when dissolved in water, such as the pentasodium salt of amino tri(methylene phosphonic acid), sodium acid phyrophosphate, disodium hydrogen phosphate, and sodium citrate, can shorten the gel time (accelerate gelling) of the composition. Buffers prepared from Bronsted acids and Bronsted bases, such as citric acid and sodium citrate, or Bronsted acids and Lewis bases, such as citric acid and monoethanolamine, buffers produced from Lewis acids and Lewis bases, such as boric acid and monoethanolamine, can function as either gel time accelerators or retarders, depending on the composition. The gel time control agent can be about 0.5% to about 10% of the composition by weight. In some cases, the gel time control agent is about 0.5% to about 2.5% of the composition by weight.

In some embodiments, the composition further includes an aqueous carrier. The aqueous carrier can include water, brine, produced water, flowback water, brackish water, sea water, or combinations thereof. In some embodiments, the aqueous carrier is about 50% to about 98% by weight of the composition. In some embodiments, the aqueous carrier is about 5% to about 98% by weight of the composition. For example, the aqueous carrier can be about 60%-98%, 70%-98%, 80%-98%, 90%-98%, 95%-98%, or about 85%-98% by weight of the composition or about 50%, 60%, 70%, 80%, 85%, 90%, 91%, 92%, 93%, 94%, 95%, 96%, 97%, or about 98% by weight of the composition.

In some embodiments, the composition has a gel time of less than about 24 hours at about 100° F. to 180° F. For example, the composition can have a gel time of less than about 2 hours at about 100° F. to 180° F.

Also provided in this disclosure is a composition including a maleic anhydride copolymer, an aminosilane crosslinker, and an aqueous carrier. The maleic anhydride copolymer includes the repeat units:

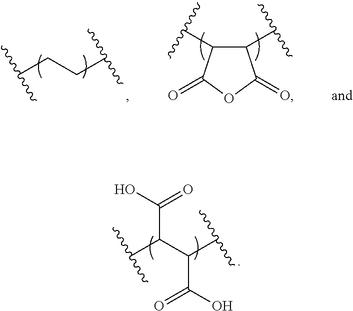

The aqueous carrier includes water, brine, produced water, flowback water, brackish water, sea water, or combinations thereof.

In embodiments including a polyamine crosslinker, the polyamine crosslinker may be selected from the group consisting of polyethyleneimine and TEPA. The polyethyleneimine can have a weight-average molecular weight of about 1,800 Da. The polyethyleneimine can have a weight-average molecular weight of about 750,000 Da. In some embodiments, the polyamine crosslinker is TEPA.

In some embodiments, the aqueous carrier can include water, brine, produced water, flowback water, brackish water, sea water, or combinations thereof.

Additionally, provided in this disclosure is a composition including a maleic anhydride copolymer, an aminosilane crosslinker, and an aqueous carrier. The maleic anhydride copolymer includes the repeat units:

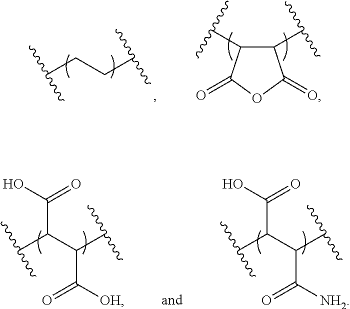

The aqueous carrier includes water, brine, produced water, flowback water, brackish water, sea water, or combinations thereof.

Additionally, provided in this disclosure is a composition including a maleic anhydride copolymer, an aminosilane crosslinker, and an aqueous carrier. The maleic anhydride copolymer includes the repeat units:

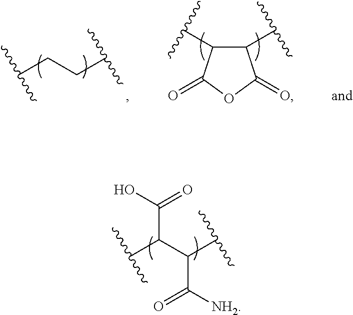

The aqueous carrier includes water, brine, produced water, flowback water, brackish water, sea water, or combinations thereof.

In embodiments that include a polyamine crosslinker, the polyamine crosslinker may be selected from the group consisting of polyethyleneimine and TEPA. The polyethyleneimine can have a weight-average molecular weight of about 1,800 Da. The polyethyleneimine can have a weight-average molecular weight of about 750,000 Da. In some embodiments the polyamine crosslinker is TEPA.

In some embodiments, the aqueous carrier can include water, brine, produced water, flowback water, brackish water, sea water, or combinations thereof.

Also provided in this disclosure is a composition including a maleic anhydride copolymer, an aminosilane crosslinker, and an aqueous carrier. The maleic anhydride copolymer includes the repeat units:

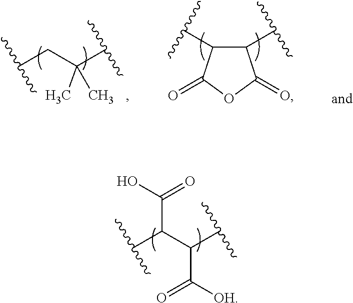

The aqueous carrier includes water, brine, produced water, flowback water, brackish water, sea water, or combinations thereof.

In embodiments including a polyamine crosslinker, the polyamine crosslinker may be selected from the group consisting of polyethyleneimine and TEPA. The polyethyleneimine can have a weight-average molecular weight of about 1,800 Da. The polyethyleneimine can have a weight-average molecular weight of about 750,000 Da.

In some embodiments the polyamine crosslinker is TEPA. The ratio of the maleic anhydride copolymer to TEPA can be about 10:0.1 to about 10:3, about 10:0.2 to about 10:1, or about 10:0.3 to about 10:0.7. The ratio of the maleic anhydride copolymer to TEPA can be about 10:0.1, about 10:0.3, about 10:0.4, about 10:0.5, about 10:0.6, about 10:0.7, about 10:1, or about 10:2. In some embodiments, ratio of the maleic anhydride copolymer to TEPA can be about 10:0.5. In some embodiments, the weight ratio of aminosilane to polyamine is 100:1 to 1:1, alternately 50:1 to 1:1 or 10:1 to 1:1.

In some embodiments, the aqueous carrier can include water, brine, produced water, flowback water, brackish water, sea water, or combinations thereof.

The composition can have a basic pH or an acidic pH. In some examples, the composition has a pH of about 3 to 10, about 7 to about 10, or about 8 to about 9. In other examples, the composition has a pH of about 3 to about 6, about 3 to about 7, or about 4 to about 6.

Additionally, provided in this disclosure is a composition including a maleic anhydride copolymer, an aminosilane crosslinker, and an aqueous carrier. The maleic anhydride copolymer includes the repeat units:

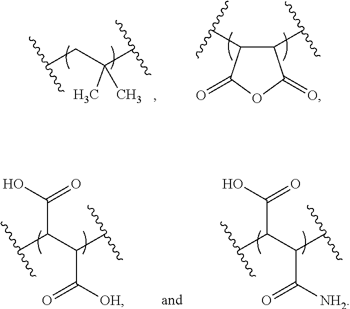

The aqueous carrier includes water, brine, produced water, flowback water, brackish water, sea water, or combinations thereof.

Additionally, provided in this disclosure is a composition including a maleic anhydride copolymer, an aminosilane crosslinker, and an aqueous carrier. The maleic anhydride copolymer includes the repeat units:

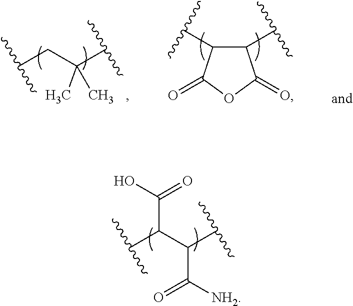

The aqueous carrier includes water, brine, produced water, flowback water, brackish water, sea water, or combinations thereof.

In embodiments including a polyamine crosslinker, the polyamine crosslinker may be selected from the group consisting of polyethyleneimine and TEPA. The polyethyleneimine can have a weight-average molecular weight of about 1,800 Da. The polyethyleneimine can have a weight-average molecular weight of about 750,000 Da.

In some embodiments, the polyamine crosslinker is TEPA. The ratio of the maleic anhydride copolymer to TEPA can be about 10:0.1 to about 10:3, about 10:0.2 to about 10:1, or about 10:0.3 to about 10:0.7. The ratio of the maleic anhydride copolymer to TEPA can be about 10:0.1, about 10:0.3, about 10:0.4, about 10:0.5, about 10:0.6, about 10:0.7, about 10:1, about 10:1, or about 10:2. In some embodiments, ratio of the maleic anhydride copolymer to TEPA can be about 10:0.5.

In some embodiments, the aqueous carrier can include water, brine, produced water, flowback water, brackish water, sea water, or combinations thereof.

The composition can have a basic pH. For example, the composition can have a pH of about 7 to about 10, about 7.5 to about 10, or about 8 to about 9. In some embodiments, the composition has a pH of about 8 to about 9. The composition can have a pH of about 7.5, 8, 8.5, 9, or 10.

### Producing Maleic Anhydride Copolymers

In one example, maleic anhydride copolymers containing the second repeat unit III can be produced by exposing a maleic anhydride copolymer including repeat units I and II to a sodium hydroxide solution. Each R¹ is independently selected from the group consisting of —H, —O(C₁-C₅) alkyl, and —(C₁-C₅) alkyl. Each R² is independently selected from the group consisting of —H, —O(C₁-C₅) alkyl, and —(C₁-C₅) alkyl. Exposure to the sodium hydroxide solution can hydrolyze a portion of the maleic anhydride functional groups to provide the 1,2-dicarboxylic acid repeat unit III as its sodium salt. Other suitable basic solutions can also be used hydrolyze at least a portion of the maleic anhydride repeat units of the maleic anhydride copolymer. The ratio of repeat units III to II can be increased, in one example, by increasing the equivalents of sodium hydroxide used in the hydrolysis reaction and/or increasing the reaction time. Alternatively, acid catalyzed hydrolysis may be used to produce the 1,2-dicarboxylic acid repeat unit III from at least a portion of the maleic anhydride repeat units present in the maleic anhydride copolymer.

In one example, maleic anhydride copolymers containing repeat unit IV can be produced by exposing a maleic anhydride copolymer including the repeat units I and II to an ammonium hydroxide solution. Each R¹ is independently selected from the group consisting of —H, —O(C₁-C₅) alkyl, and —(C₁-C₅) alkyl. Each R² is independently selected from the group consisting of —H, —O(C₁-C₅) alkyl, and —(C₁-C₅) alkyl. Exposure to the ammonium hydroxide solution hydrolyzes and ammonolyzes a portion of the maleic anhydride functional groups to provide repeat units III and IV, a carboxylic acid/amide repeat unit. Other suitable solutions can also be used to form second repeat unit IV. The ratio of repeat units IV to II can be increased by increasing the equivalents of ammonium hydroxide used in the hydrolysis reaction (e.g., hydrolysis/ammonolysis) and/or increasing the reaction time.

### Other Components

In various embodiments, the composition including the maleic anhydride copolymer and aminosilane crosslinker can further include one or more suitable additional components.

The composition including the maleic anhydride copolymer and aminosilane crosslinker can further include one or more fluids. The composition can include a fluid including at least one of dipropylene glycol methyl ether, dipropylene glycol dimethyl ether, dimethyl formamide, diethylene glycol methyl ether, ethylene glycol butyl ether, diethylene glycol butyl ether, propylene carbonate, D-limonene, a C₂-C₄₀ fatty acid C₁-C₁₀ alkyl ester, 2-butoxy ethanol, butyl acetate, furfuryl acetate, dimethyl sulfoxide, dimethyl formamide, diesel, kerosene, mineral oil, a hydrocarbon including an internal olefin, a hydrocarbon including an alpha olefin, xylenes, an ionic liquid, methyl ethyl ketone, and cyclohexanone. The composition can include any suitable proportion of the one or more fluids, such as about 0.001% to about 40%, about 20% to about 40%, or about 0.001% or less by weight, or about 0.01%, 0.1%, 1%, 2%, 3%, 4%, 5%, 10%, 15%, 20%, 30%, 40%, or more by weight of the composition.

The composition can further include a viscosifier in addition to the maleic anhydride copolymer and aminosilane crosslinker. The viscosifier can be present in any suitable concentration, such as more, less, or an equal concentration as compared to the concentration of the maleic anhydride copolymer, polyamine crosslinker, and gel time control agent. The viscosifier can include at least one of a substituted or unsubstituted polysaccharide. The viscosifier can include a polymer including at least one monomer selected from the group consisting of ethylene glycol, acrylamide, vinyl acetate, 2-acrylamidomethyl-propane sulfonic acid or its salts, trimethylammoniumethyl acrylate halide, and trimethylammoniumethyl methacrylate halide.

The composition including the maleic anhydride copolymer and aminosilane crosslinker can be combined with any suitable downhole fluid before, during, or after the placement of the composition in a subterranean formation or the contacting of the composition and a subterranean material. For example, the composition including the maleic anhydride copolymer, polyamine crosslinker, and gel time control agent can be combined with a downhole fluid above the surface, and then the combined composition is placed in a subterranean formation or contacted with a subterranean material. Alternatively, the composition including the maleic anhydride copolymer and aminosilane crosslinker can be injected into a subterranean formation to combine with a downhole fluid, and the combined composition is contacted with a subterranean material or is considered to be placed in the subterranean formation. In some embodiments, at least one of prior to, during, and after the placement of the composition in the subterranean formation or contacting of the subterranean material and the composition, the composition is used in the subterranean formation alone or in combination with other materials, as a drilling fluid, stimulation fluid, fracturing fluid, spotting fluid, clean-up fluid, completion fluid, remedial treatment fluid, abandonment fluid, pill, acidizing fluid, cementing fluid, packer fluid, or a combination thereof.

A drilling fluid, also known as a drilling mud or simply “mud,” is a specially designed fluid that is circulated through a wellbore as the wellbore is being drilled to facilitate the drilling operation. The drilling fluid can be water-based or oil-based. The drilling fluid can carry cuttings up from beneath and around the bit, transport them up the annulus, and allow their separation. Also, a drilling fluid can cool and lubricate the drill head as well as reduce friction between the drill string and the sides of the hole. The drilling fluid aids in support of the drill pipe and drill head, and provides a hydrostatic head to maintain the integrity of the wellbore walls and prevent well blowouts. Specific drilling fluid systems can be selected to optimize a drilling operation in accordance with the characteristics of a particular geological formation. The drilling fluid can be formulated to prevent unwanted influxes of formation fluids from permeable rocks and also to form a thin, low permeability filter cake that temporarily seals pores, other openings, and formations penetrated by the bit. In water-based drilling fluids, solid particles are suspended in a water or brine solution containing other components. Oils or other non-aqueous liquids can be emulsified in the water or brine or at least partially solubilized (for less hydrophobic non-aqueous liquids), but water is the continuous phase. A drilling fluid can be present in the mixture with the composition including the maleic anhydride copolymer and aminosilane crosslinker in any suitable amount, such as about 1% or less by weight of the composition, about 2%, 3%, 4%, 5%, 10%, 15%, 20%, 30%, 40%, 50%, 60%, 70%, 80%, 85%, 90%, 95%, 96%, 97%, 98%, or about 99% or more by weight of the mixture.

A pill is a relatively small quantity (e.g., less than about 500 bbl, or less than about 200 bbl) of drilling fluid used to accomplish a specific task that the regular drilling fluid cannot perform. For example, a pill can be a high-viscosity pill to, for example, help lift cuttings out of a vertical wellbore. In another example, a pill can be a freshwater pill to, for example, dissolve a salt formation. Another example is a pipe-freeing pill to, for example, destroy filter cake and relieve differential sticking forces. In another example, a pill is a lost circulation material pill to, for example, plug a thief zone. A pill can include any component described herein as a component of a drilling fluid.

The crosslinked reaction product can form a sealant (e.g., a sealant gel). In some embodiments, the sealant is a stiff gel, a ringing gel, or a lipping gel.

### Treating a Subterranean Formation

Treating a subterranean formation includes providing to a subterranean formation a composition and crosslinking the composition to form a sealant. The composition includes a maleic anhydride copolymer and an aminosilane crosslinker. The maleic anhydride copolymer includes first repeat units I and II. The maleic anhydride copolymer further includes at least one second repeat unit selected from the group consisting of repeat units III and IV.

In some embodiments, the providing occurs above-surface. The providing can also occur in the subterranean formation.

In some embodiments, forming the sealant occurs near at least one of a casing, a casing-casing annulus, a tubing-casing annulus, or a casing-formation annulus. In some embodiments, forming the sealant occurs in a void, such as a crack, microannulus, and the like in a pipe and other structures in the presence or absence of set cement.

In some embodiments, forming a sealant from the composition prevents or retards undesired loss or flow of wellbore fluid into the formation or of formation fluids into the wellbore. In some embodiments, the sealant prevents or retards undesired loss or leak off of fluid into the formation.

Also, provided in this disclosure is a method of preventing or alleviating loss of drilling fluid or other fluid circulation in a wellbore penetrating a subterranean formation. In some embodiments, the composition including the maleic anhydride copolymer and aminosilane crosslinker is provided in a weighted or unweighted “pill” for introduction into the wellbore. Such “pills” typically include the composition blended with a required amount of water, base oil, water base drilling fluid, or non-aqueous base drilling fluid and in some cases a weighting agent such as barite, calcium carbonate, or a salt. The amount of the composition used in the pill depends on the size of the subterranean fracture, opening, or lost circulation zone to be treated. Multiple pills or treatments may be used if needed. In some embodiments, drilling is stopped while the pill including the composition is introduced into the wellbore. The composition can enter lost circulation zones or porous or fractured portions of the formation where it will prevent or retard the entry of drilling and other wellbore fluids. Further, pressure can be used to squeeze the pill into the lost circulation zone and de-fluidize a slurry. In some embodiments, the composition including the maleic anhydride copolymer and aminosilane crosslinker also contains loss circulation materials capable of packing inside the loss circulation zone and forming a solid bridge across the loss circulation zone while the resin sets in and around the packed block thereby enhancing the effectiveness of the loss circulation material.

Servicing a wellbore includes providing a composition including a maleic anhydride copolymer and an aminosilane crosslinker within a portion of at least one of a wellbore and a subterranean formation. The maleic anhydride copolymer includes first repeat units I and II. The maleic anhydride copolymer further includes at least one second repeat unit selected from the group consisting of repeat units III and IV.

In some embodiments, the composition is introduced into at least one of a wellbore and a subterranean formation using a pump. The maleic anhydride copolymer and the aminosilane crosslinker can be pumped together from at least one source or simultaneously from at least two different sources. Alternatively, the maleic anhydride copolymer can be pumped first and the aminosilane crosslinker can be pumped second, or the aminosilane crosslinker can be pumped first and the maleic anhydride copolymer can be pumped second.

In some embodiments, an aqueous solution containing a gelling agent is introduced into at least one of a wellbore and a subterranean formation gelling agent “preflush” or “pretreatment”) prior to introduction of a composition including a maleic anhydride copolymer and an aminosilane crosslinker. The composition may be free of a gelling agent. In other embodiments, an aqueous solution containing a first gelling agent is introduced into at least one of a wellbore and a subterranean formation prior to introduction of a composition including a maleic anhydride copolymer and a second gelling agent. The first gelling agent and the second gelling agent may be the same or different. In some cases, pretreatment with a gelling agent is performed to condition set cement prior to forming a gel in contact with the set cement. The pretreatment may promote gelling of the composition in contact with the set cement, and may accelerate or retard the rate at which the gel is formed. In some cases, an aqueous solution of sodium phosphate may be introduced into at least one of a wellbore and a subterranean formation as a pretreatment prior to introduction of a composition including maleic anhydride copolymer and an aminosilane crosslinker.

### Other Information

Reference is made in detail to certain embodiments of the disclosed subject matter. While the disclosed subject matter will be described in conjunction with the claims, the exemplified subject matter is not intended to limit the claims to the disclosed subject matter.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

In the disclosed methods of manufacturing, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” can allow for a degree of variability in a value or range, for example, within 10%, within 5%, or within 1% of a stated value or of a stated limit of a range.

The term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “organic group” refers to but is not limited to any carbon-containing functional group. For example, an oxygen-containing group such as an alkoxy group, aryloxy group, aralkyloxy group, oxo(carbonyl) group, a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, or C(═NOR)R, where R can be hydrogen (in examples that include other carbon atoms) or a carbon-based moiety, and where the carbon-based moiety can itself be further substituted.

The term “substituted” refers to an organic group or molecule in which one or more hydrogen atoms in the group or molecule are replaced by one or more non-hydrogen atoms. The term “functional group” or “substituent” refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups.

The term “alkyl” refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. The term “alkyl” encompasses n-alkyl, isoalkyl, and anteisoalkyl groups as well as other branched chain forms of alkyl. Representative substituted alkyl groups can be substituted one or more times with any of the disclosed groups, for example, amino, hydroxy, cyano, carboxy, nitro, thio, alkoxy, and halogen groups.

The term “cycloalkyl” refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups. Representative substituted cycloalkyl groups can be mono-substituted or substituted more than once, such as, but not limited to, 2,2-, 2,3-, 2,4-2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

The term “alkenyl” refers to straight and branched chain and cyclic alkyl groups, except that at least one double bond exists between two carbon atoms. Thus, alkenyl groups have from 2 to 40 carbon atoms, or 2 to about 20 carbon atoms, or 2 to 12 carbons or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “alkynyl” refers to straight and branched chain alkyl groups, except that at least one triple bond exists between two carbon atoms. Thus, alkynyl groups have from 2 to 40 carbon atoms, 2 to about 20 carbon atoms, or from 2 to 12 carbons or, in some embodiments, from 2 to 8 carbon atoms. Examples include, but are not limited to —C≡CH, —C≡C(CH₃), —C≡C(CH₂CH₃), —CH₂C≡CH, —CH₂C≡C(CH₃), and —CH₂C≡C(CH₂CH₃) among others.

The term “acyl” refers to a group containing a carbonyl moiety where the group is bonded via the carbonyl carbon atom. The carbonyl carbon atom is also bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. In the special case in which the carbonyl carbon atom is bonded to a hydrogen, the group is a “formyl” group, an acyl group. An acyl group can include 0 to about 12-20 or 12-40 additional carbon atoms bonded to the carbonyl group. An acyl group can include double or triple bonds. An acryloyl group is an example of an acyl group. An acyl group can also include heteroatoms. A nicotinoyl group (pyridyl-3-carbonyl) is an example of an acyl group. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “aryl” refers to cyclic aromatic hydrocarbons that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted. Representative substituted aryl groups can be mono-substituted or substituted more than once, such as, but not limited to, 2-, 3-, 4-, 5-, or 6-substituted phenyl or 2-8 substituted naphthyl groups, which can be substituted with carbon or non-carbon groups.

The term “aralkyl” refers to alkyl groups in which a hydrogen or carbon bond of an alkyl group is replaced with a bond to an aryl group. Representative aralkyl groups include benzyl and phenylethyl groups and fused (cycloalkylaryl) alkyl groups such as 4-ethyl-indanyl. Aralkenyl groups are alkenyl groups in which a hydrogen or carbon bond of an alkyl group is replaced with a bond to an aryl group.

The term “heterocyclyl” refers to aromatic and non-aromatic ring compounds containing three or more ring members, of which one or more is a heteroatom such as, but not limited to, N, O, and S. Thus, a heterocyclyl can be a cycloheteroalkyl, or a heteroaryl, or if polycyclic, any combination thereof. In some embodiments, heterocyclyl groups include 3 to about 20 ring members, whereas other such groups have 3 to about 15 ring members. A heterocyclyl group designated as a C₂-heterocyclyl can be a 5-ring with two carbon atoms and three heteroatoms, a 6-ring with two carbon atoms and four heteroatoms and so forth. Likewise, a C₄-heterocyclyl can be a 5-ring with one heteroatom, a 6-ring with two heteroatoms, and so forth. The number of carbon atoms plus the number of heteroatoms equals the total number of ring atoms. A heterocyclyl ring can also include one or more double bonds. A heteroaryl ring is an embodiment of a heterocyclyl group. The phrase “heterocyclyl group” includes fused ring species including those that include fused aromatic and non-aromatic groups.

The term “heterocyclylalkyl” refers to alkyl groups in which a hydrogen or carbon bond of an alkyl group is replaced with a bond to a heterocyclyl group. Representative heterocyclyl alkyl groups include, but are not limited to, furan-2-yl methyl, furan-3-yl methyl, pyridine-3-yl methyl, tetrahydrofuran-2-yl ethyl, and indol-2-yl propyl.

The term “heteroarylalkyl” refers to alkyl groups in which a hydrogen or carbon bond of an alkyl group is replaced with a bond to a heteroaryl group.

The term “alkoxy” refers to an oxygen atom connected to an alkyl group, including a cycloalkyl group. Examples of linear alkoxy groups include but are not limited to methoxy, ethoxy, propoxy, butoxy, pentyloxy, hexyloxy, and the like. Examples of branched alkoxy groups include but are not limited to isopropoxy, sec-butoxy, tert-butoxy, isopentyloxy, isohexyloxy, and the like. Examples of cyclic alkoxy groups include but are not limited to cyclopropyloxy, cyclobutyloxy, cyclopentyloxy, cyclohexyloxy, and the like. An alkoxy group can include one to about 12-20 or about 12-40 carbon atoms bonded to the oxygen atom, and can further include double or triple bonds, and can also include heteroatoms. For example, an allyloxy group is considered to be an alkoxy group. A methoxyethoxy group is also considered to be an alkoxy group, as is a methylenedioxy group in a context where two adjacent atoms of a structure are substituted therewith.

The term “amine” refers to primary, secondary, and tertiary amines having, for example, the formula N(group)₃, where each group can independently be H or non-H, such as alkyl, aryl, and the like. Amines include but are not limited to R—NH₂, for example, alkylamines, arylamines, alkylarylamines; R₂NH where each R is independently selected, such as dialkylamines, diarylamines, aralkylamines, heterocyclylamines and the like; and R₃N where each R is independently selected, such as trialkylamines, dialkylarylamines, alkyldiarylamines, triarylamines, and the like.

The term “amino group” refers to a substituent of the form —NH₂, —NHR, and —NR₂, where each R is independently selected. Accordingly, any compound substituted with an amino group can be viewed as an amine. An “amino group” can be a primary, secondary, or tertiary. An “alkylamino” group includes a monoalkylamino, dialkylamino, and trialkylamino group.

The terms “halo,” “halogen,” or “halide” group, by themselves or as part of another substituent, mean, unless otherwise stated, a fluorine, chlorine, bromine, or iodine atom.

The term “haloalkyl” group, includes mono-halo alkyl groups, poly-halo alkyl groups where all halo atoms can be the same or different, and per-halo alkyl groups, where all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “hydrocarbon” refers to a functional group or molecule that includes carbon and hydrogen atoms. The term can also refer to a functional group or molecule that normally includes both carbon and hydrogen atoms but where all the hydrogen atoms are substituted with other functional groups.

The term “hydrocarbyl” refers to a functional group derived from a straight chain, branched, or cyclic hydrocarbon, and can be alkyl, alkenyl, alkynyl, aryl, cycloalkyl, acyl, or any combination thereof.

The term “solvent” refers to a liquid that can dissolve a solid, another liquid, or a gas. Non-limiting examples of solvents are silicones, organic compounds, water, alcohols, ionic liquids, and supercritical fluids.

The term “number-average molecular weight” refers to the ordinary arithmetic mean of the molecular weight of individual molecules in a sample. It is defined as the total weight of all molecules in a sample divided by the total number of molecules in the sample. Experimentally, the number-average molecular weight (Mₙ) is determined by analyzing a sample divided into molecular weight fractions of species i having nᵢ molecules of molecular weight Mᵢ through the formula Mₙ=ΣMᵢnᵢ/Σnᵢ. The number-average molecular weight can be measured by a variety of well-known methods including gel permeation chromatography, spectroscopic end group analysis, and osmometry. If unspecified, molecular weights of polymers are number-average molecular weights.

The term “weight-average molecular weight” refers to M_{w}, which is equal to ΣMᵢ²nᵢ/ΣMᵢnᵢ, where nᵢ is the number of molecules of molecular weight Mᵢ. In various examples, the weight-average molecular weight can be determined using light scattering, small angle neutron scattering, X-ray scattering, and sedimentation velocity.

The term “room temperature” refers to a temperature of about 15° C. to about 28° C.

The term “standard temperature and pressure” refers to 20° C. and 101 kPa.

“Degree of polymerization” is the number of repeating units in a polymer.

The term “polymer” refers to a molecule having at least one repeating unit and can include copolymers.

The term “copolymer” refers to a polymer that includes at least two different repeating units. A copolymer can include any suitable number of repeating units.

The term “downhole” refers to under the surface of the earth, such as a location within or fluidly connected to a wellbore.

The term “drilling fluid” refers to fluids, slurries, or muds used in drilling operations downhole, such as during the formation of the wellbore.

The term “stimulation fluid” refers to fluids or slurries used downhole during stimulation activities of the well that can increase the production of a well, including perforation activities. In some examples, a stimulation fluid can include a fracturing fluid or an acidizing fluid.

The term “clean-up fluid” refers to fluids or slurries used downhole during clean-up activities of the well, such as any treatment to remove material obstructing the flow of desired material from the subterranean formation. In one example, a clean-up fluid can be an acidification treatment to remove material formed by one or more perforation treatments. In another example, a clean-up fluid can be used to remove a filter cake.

The term “fracturing fluid” refers to fluids or slurries used downhole during fracturing operations.

The term “spotting fluid” refers to fluids or slurries used downhole during spotting operations, and can be any fluid designed for localized treatment of a downhole region. In one example, a spotting fluid includes a lost circulation material for treatment of a specific section of the wellbore, such as to seal off fractures in the wellbore and prevent sag. In another example, a spotting fluid can include a water control material. In some examples, a spotting fluid can be designed to free a stuck piece of drilling or extraction equipment, can reduce torque and drag with drilling lubricants, prevent differential sticking, promote wellbore stability, and can help to control mud weight.

The term “completion fluid” refers to fluids or slurries used downhole during the completion phase of a well, including cementing compositions.

The term “remedial treatment fluid” refers to fluids or slurries used downhole for remedial treatment of a well. Remedial treatments can include treatments designed to increase or maintain the production rate of a well, such as stimulation or clean-up treatments.

The term “abandonment fluid” refers to fluids or slurries used downhole during or preceding the abandonment phase of a well.

The term “acidizing fluid” refers to fluids or slurries used downhole during acidizing treatments. In one example, an acidizing fluid is used in a clean-up operation to remove material obstructing the flow of desired material, such as material formed during a perforation operation. In some examples, an acidizing fluid can be used for damage removal.

The term “cementing fluid” refers to fluids or slurries used during cementing operations of a well. In one example, a cementing fluid includes an aqueous mixture including at least one of cement and cement kiln dust. In another example, a cementing fluid includes a curable resinous material such as a polymer that is in an at least partially uncured state.

The term “water control material” refers to a solid or liquid material that interacts with aqueous material downhole, such that hydrophobic material can more easily travel to the surface and such that hydrophilic material (including water) can less easily travel to the surface. A water control material can be used to treat a well to cause the proportion of water produced to decrease and to cause the proportion of hydrocarbons produced to increase, such as by selectively binding together material between water-producing subterranean formations and the wellbore while still allowing hydrocarbon-producing formations to maintain output.

The term “packer fluid” refers to fluids or slurries that can be placed in the annular region of a well between tubing and outer casing above a packer. In various examples, the packer fluid can provide hydrostatic pressure in order to lower differential pressure across the sealing element, lower differential pressure on the wellbore and casing to prevent collapse, and protect metals and elastomers from corrosion.

The term “fluid” refers to gases, liquids, gels, and critical and supercritical materials.

The term “subterranean material” or “subterranean formation” refers to any material under the surface of the earth, including under the surface of the bottom of the ocean. For example, a subterranean formation or material can be any section of a wellbore and any section of a subterranean petroleum- or water-producing formation or region in fluid contact with the wellbore. Placing a material in a subterranean formation can include contacting the material with any section of a wellbore or with any subterranean region in fluid contact therewith. Subterranean materials can include any materials placed into the wellbore such as cement, drill shafts, liners, tubing, casing, or screens; placing a material in a subterranean formation can include contacting with such subterranean materials. In some examples, a subterranean formation or material can be any below-ground region that can produce liquid or gaseous petroleum materials, water, or any section below-ground in fluid contact therewith. For example, a subterranean formation or material can be at least one of an area desired to be fractured, a fracture or an area surrounding a fracture, and a flow pathway or an area surrounding a flow pathway, wherein a fracture or a flow pathway can be optionally fluidly connected to a subterranean petroleum- or water-producing region, directly or through one or more fractures or flow pathways.

“Treatment of a subterranean formation” can include any activity directed to extraction of water or petroleum materials from a subterranean petroleum- or water-producing formation or region, for example, including drilling, stimulation, hydraulic fracturing, clean-up, acidizing, completion, cementing, remedial treatment, abandonment, and the like.

A “flow pathway” downhole can include any suitable subterranean flow pathway through which two subterranean locations are in fluid connection. The flow pathway can be sufficient for petroleum or water to flow from one subterranean location to the wellbore or vice-versa. A flow pathway can include at least one of a hydraulic fracture, and a fluid connection across a screen, across gravel pack, across proppant, including across resin-bonded proppant or proppant deposited in a fracture, and across sand. A flow pathway can include a natural subterranean passageway through which fluids can flow. In some embodiments, a flow pathway can be a water source and can include water. In some embodiments, a flow pathway can be a petroleum source and can include petroleum. In some embodiments, a flow pathway can be sufficient to divert from a wellbore, fracture, or flow pathway connected thereto at least one of water, a downhole fluid, or a produced hydrocarbon.

### Examples

The polymer used in these examples, obtained from a commercial source (ISOBAM 104 from Kuraray Co., Ltd.), was partially hydrolyzed/ammonolyzed poly(maleic anhydride/isobutylene) copolymer with a monomer ratio of 1:1 and a weight-average molecular weight of 5.5-6.5×10⁴ hydrolyzed/ammonolyzed with ammonium hydroxide to generate amide-ammonium type hydrolyzed functional groups. 3-aminopropyl-triethoxysilane, 2-aminoethyl-3-aminopropyltrimethoxy-silane, and N′-(3-trimethoxysilylpropyl)diethylenetriamine (available from Sigma Aldrich), having a single primary amine and 0, 1, or 2 secondary amines, respectively, were used as aminosilane crosslinkers.

Compositions were prepared by dissolving the polymer in water to prepare a 10% by weight solution of the polymer and adding the aminosilane crosslinker with stirring. In some cases, a salt (sodium phosphate) or a polyamine crosslinker (TEPA) was added with stirring. The solution mixtures were put in glass test tubes and kept in an oven at the specified temperature. Gel time refers to the length of time to reach 10,000 cP as measured on a Brookfield DVT Viscometer (Brookfield Engineering Laboratories, Inc.). Viscosity was monitored as a function of time at the specified temperature using a #3 spindle. In all cases, the gels were stiff ringing type gels. A ‘stiff gel’ may be defined as a gel that when taken out of its container retains its shape and does not permanently deform upon application of a small force. A ‘ringing gel’ is defined as a gel that when a container containing the gel is gently tapped on a hard surface, it will vibrate like a tuning fork. A ‘lipping or weaker’ gel’ is defined as a gel that when a container holding the gel is tilted, the gel will deform and tend to flow/extend, elastically, in the direction of the tilt.

Table 1 lists gel times (GT) in minutes for Products A-K at 180° F. or 190° F. Products A-I were prepared by mixing 10 wt % polymer, the indicated wt % aminosilane crosslinker, and the balance water, and heating to form a gel as described above. Products J and K were prepared by mixing 10 wt % polymer, 2 wt % sodium phosphate (Na₃PO₄), the indicated wt % of aminosilane, and the balance water, and heating to form a gel as described above. For Samples J and K, pieces of set cement were placed in the glass test tubes and the gels were allowed to cure around the set cement.

TABLE 1
Gel times for compositions of maleic anhydride copolymer and aminosilane crosslinker

| | Temp. | | Aminosilane | Na₃PO₄ | GT |
|---|---|---|---|---|---|
| Sample | (° F.) | Aminosilane Crosslinker | (wt %) | (wt %) | (min) |
| A | 180 | 2-aminoethyl-3-aminopropyltrimethoxysilane | 2 | | 26 |
| B | 180 | 2-aminoethyl-3-aminopropyltrimethoxysilane | 4 | | 30 |
| C | 190 | 2-aminoethyl-3-aminopropyltrimethoxysilane | 2 | | 19 |
| D | 180 | 3-aminopropyltriethoxysilane | 2 | | 27 |
| E | 190 | 3-aminopropyltriethoxysilane | 2 | | 17 |
| F | 180 | N¹-(3-trimethoxysilylpropyl)diethylenetriamine | 2 | | 37 |
| G | 190 | N¹-(3-trimethoxysilylpropyl)diethylenetriamine | 2 | | 26 |
| H | 180 | N¹-(3-trimethoxysilylpropyl)diethylenetriamine | 1 | | 39 |
| I | 180 | N¹-(3-trimethoxysilylpropyl)diethylenetriamine | 0.4 | | No gel |
| J | 180 | 2-aminoethyl-3-aminopropyltrimethoxysilane | 1 | 2 | 27 |
| K | 180 | N¹-(3-trimethoxysilylpropyl)diethylenetriamine | 1 | 2 | 44 |

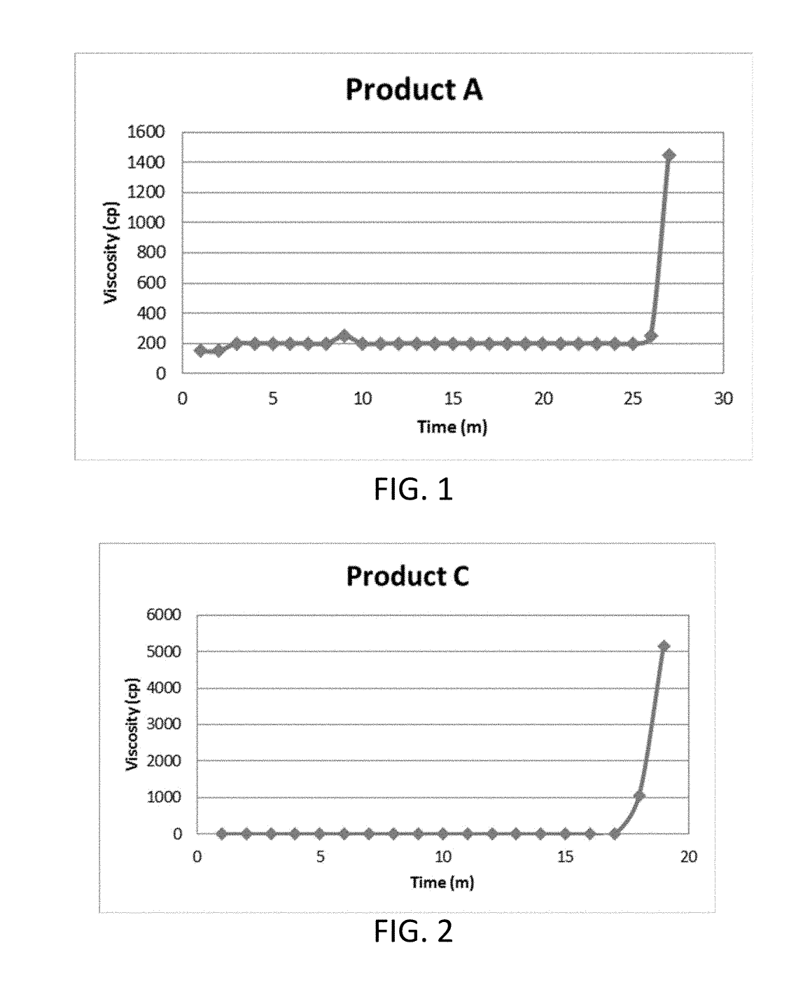

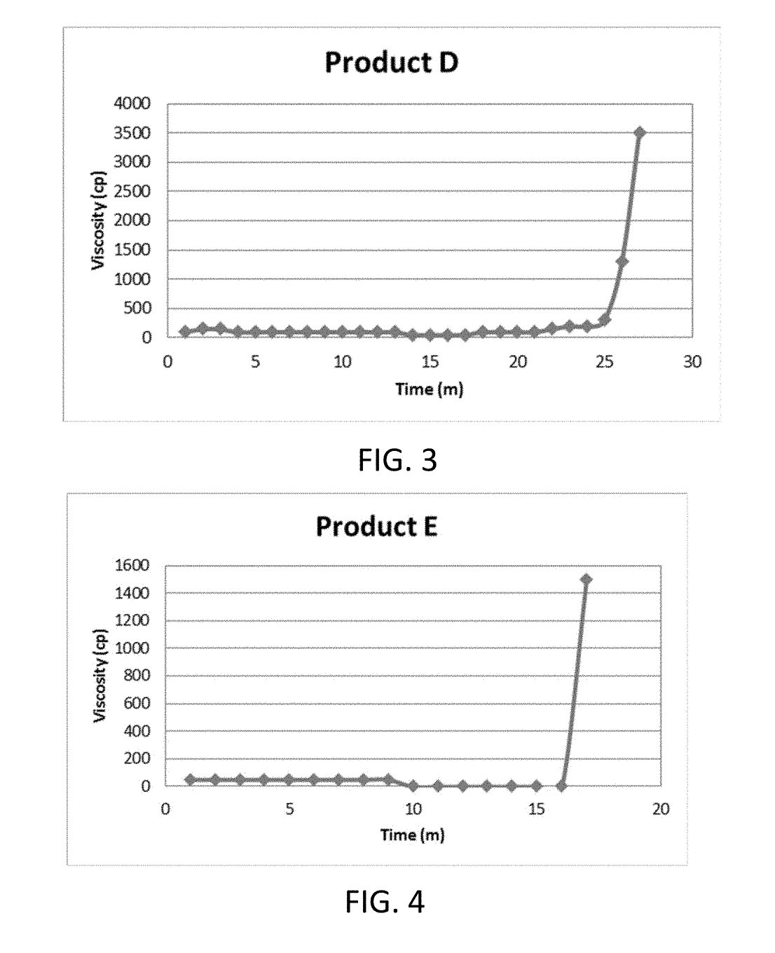

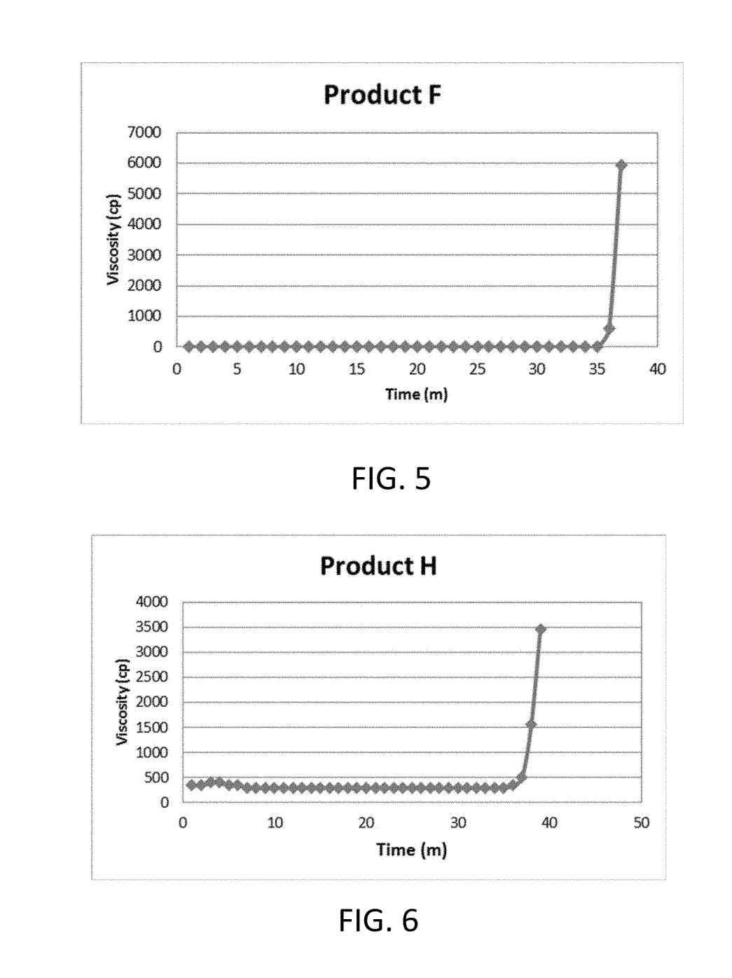

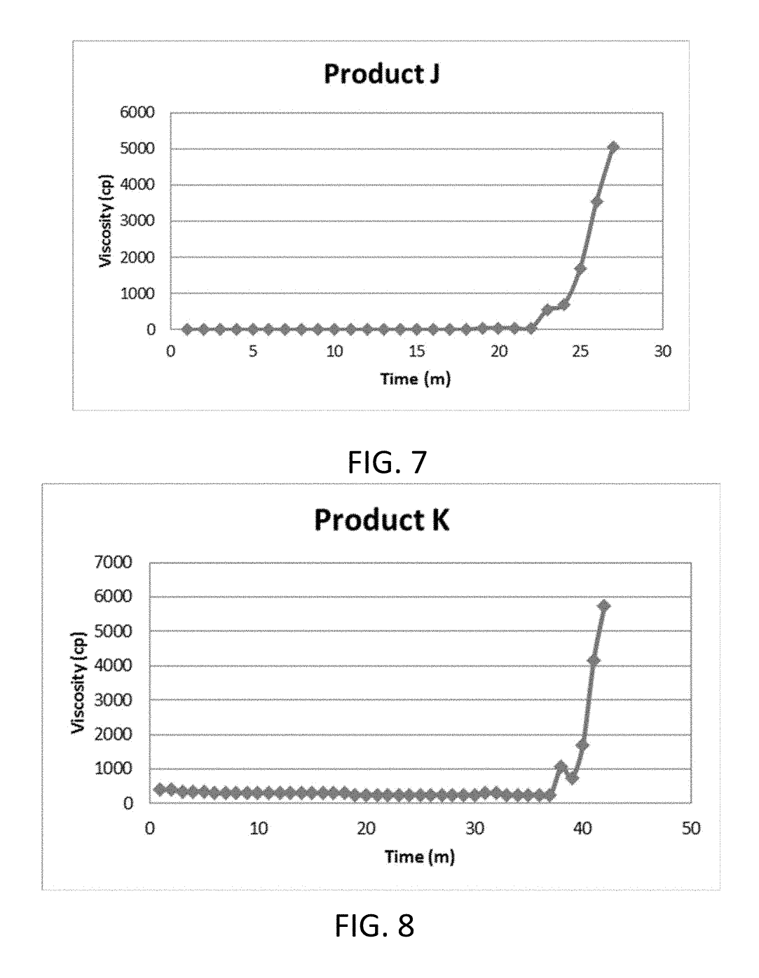

Gel times (GT) for Products A-H, J, and K ranged from 17 min to 44 min. Product I, with 0.4 wt % aminosilane, did not gel. Thus, the aminosilane crosslinkers, in certain amounts, were effective crosslinkers. Continued heating at 180° F. revealed no indication of gel syneresis over time. FIGS. 1-8 show plots of viscosity versus time for Products A, C, D, E, F, H, J, and K, respectively. Products A-H, J, and K demonstrated sharp transition times, indicating that the compositions were suitable for penetrating into fissures and gaps, while exhibiting the ability to quickly set to a strong gel to block any further flow of gas or liquid phase.

Table 2 lists gel times (GT) for Products L-M at 180° F. Product L was prepared by mixing 10 wt % polymer, 0.4 wt % N¹-(3-trimethoxysilylpropyl)diethylenetriamine, 0.4 wt % TEPA, and the balance water. Products M and N were prepared by mixing 10 wt % polymer, 2 wt % sodium phosphate (Na₃PO₄), 0.4 wt % aminosilane, and the balance water. For Products M and N, pieces of cement pieces were placed in the glass test tubes, and the gel was allowed to cure around the cement.

TABLE 2
Gel times for compositions including maleic anhydride copolymer, aminosilane
crosslinker, and polyamine crosslinker

| | Temp. | | Aminosilane | TEPA | Na₃PO₄ | GT |
|---|---|---|---|---|---|---|
| Product | (° F.) | Aminosilane Crosslinker | (wt %) | (wt %) | (wt %) | (min) |
| L | 180 | N¹-(3-trimethoxysilylpropyl)diethylenetriamine | 0.4 | 0.4 | | 50 |
| M | 180 | 2-aminoethyl-3-aminopropyltrimethoxysilane | 0.4 | 0.4 | 2 | 43 |
| N | 180 | N¹-(3-trimethoxysilylpropyl)diethylenetriamine | 0.4 | 0.4 | 2 | 50 |

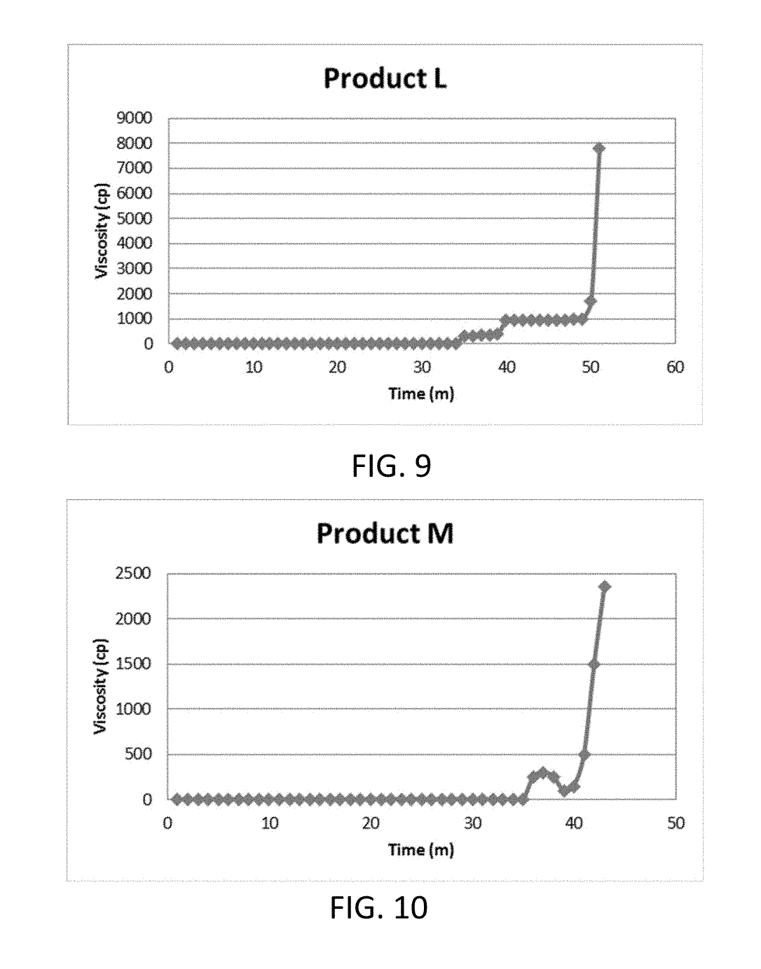

FIGS. 9 and 10 show plots of viscosity versus time for Products L and M, respectively. Products L-N all demonstrated sharp transition times, indicating that the compositions were suitable for penetrating into fissures and gaps, while exhibiting the ability to quickly set to a strong gel to block any further flow of gas or liquid phase. The composition of Product L is the composition of Product I with the addition of 0.4 wt % TEPA. Although Product I did not gel at 180° F., Product L gelled in 50 min at 180° F. Thus, Product L, with 0.4 wt % N¹-(3-trimethoxy-silylpropyl)diethylenetriamine and 0.4 wt % TEPA had a gel time of 50 min, while Product H, with 1 wt % N¹-(3-trimethoxysilylpropyl)diethylene-triamine, had a gel time of 39 min. Product M, with 0.4 wt % 2-aminoethyl-3-aminopropyl-trimethoxysilane, 0.4 wt % TEPA, and 2 wt % trisodium phosphate, had a gel time of 43 min, while Product J, with 1 wt % 2-aminoethyl-3-aminopropyltrimethoxysilane and 2 wt % trisodium phosphate, had a gel time of 27 min. Product N, with 0.4 wt % N¹-(3-trimethoxysilylpropyl)-diethylenetriamine, 0.4 wt % TEPA, and 2 wt % trisodium phosphate, had a gel time of 50 min, while Product K, with 1 wt % N¹-(3-trimethoxy-silylpropyl)diethylene-triamine and 2 wt % sodium phosphate, had a gel time of 27 min. Thus, a composition having an aminosilane crosslinker and a polyamine crosslinker demonstrates gel times close to those of compositions that have a greater total concentration of aminosilane (standard dose rate of 1%), showing a complementary effect and allowing for additional control of the system. That is, including an aminosilane crosslinker with a polyamine crosslinker is seen to reduce the total amount of crosslinker needed for comparable gel times.

Continued heating at 180° F. of Products L-N shows no indication of gel syneresis or gel breakdown over time. Products L-N all exhibit a sharp transition time, and are therefore suitable for penetrating into fissures and gaps, while exhibiting the ability to quickly set to a strong gel to block any further flow of gas or liquid phases.

In some examples, cement pieces to be added to the compositions before gel formation were pretreated with a 5 wt % sodium phosphate solution by soaking the cement pieces in the phosphate solution for 10-15 minutes, and the pretreated cement placed into the maleic anhydride copolymer composition. For a maleic anhydride copolymer composition comprised of 82.2 wt % water, 14.5 wt % ISOBAM 104, 2.4 wt % citric acid, 0.5 wt % Na₃PO₄, and 0.4 wt % TEPA, the gel time was 120 minutes at 100° F. when pretreated cement pieces were included, which exceeds the gel time of 90 minutes for the same composition when untreated cement pieces were included.

### Other Embodiments

Particular implementations of the subject matter have been described. Other implementations, alterations, and permutations of the described implementations are within the scope of the following claims as will be apparent to those skilled in the art. Accordingly, the above description of example implementations does not define or constrain this disclosure. Other changes, substitutions, and alterations are also possible without departing from the spirit and scope of this disclosure.

What is claimed is:

1. A composition for treating a subterranean formation, the composition comprising:
a maleic anhydride copolymer comprising:
first repeat units I and II: 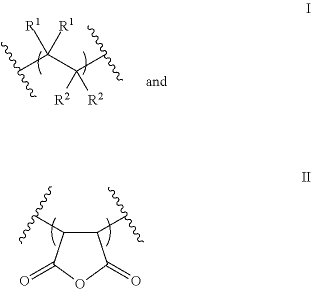
wherein each R¹ is independently selected from the group consisting of —H, —O(C₁-C₅) alkyl, and —(C₁-C₅) alkyl, and each R² is independently selected from the group consisting of —H, —O(C₁-C₅) alkyl, and —(C₁-C₅) alkyl; and
at least one second repeat unit selected from the group consisting of repeat units III and IV: 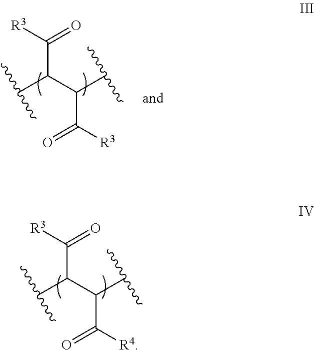
wherein each R³ is independently selected from the group consisting of —OH and —O⁻M¹, each M¹ is independently selected from the group consisting of an alkali metal, an alkaline earth metal, an ammonium ion, and a quaternary ammonium ion, and each R⁴ is independently selected from the group consisting of —NH₂ and —OM¹; and
an aminosilane crosslinker having at least one primary amine group.

2. The composition of claim 1, wherein repeat unit III and repeat unit IV comprise repeat unit IIIA and repeat unit IVA, respectively:

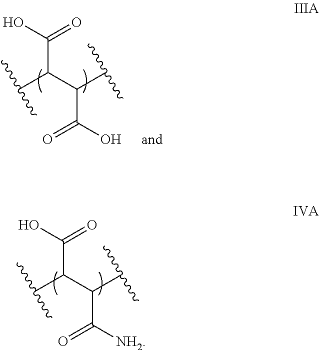

3. The composition of claim 1, wherein the aminosilane crosslinker is an aminoalkoxysilane.

4. The composition of claim 3, wherein the aminoalkoxysilane is an aminotrialkoxysilane.

5. The composition of claim 3, wherein the aminosilane crosslinker has 0, 1, or 2 secondary amine groups.

6. The composition of claim 3, wherein the aminosilane crosslinker is 3-aminopropyl-triethoxysilane.

7. The composition of claim 3, wherein the aminosilane crosslinker is 2-aminoethyl-3-aminopropyltrimethoxysilane.

8. The composition of claim 3, wherein the aminosilane crosslinker is N¹-(3-trimethoxysilylpropyl)diethylenetriamine.

9. The composition of claim 1, wherein the aminosilane crosslinker is 0.5% to 10% by weight of the composition.

10. The composition of claim 1, comprising a polyamine crosslinker, wherein the polyamine crosslinker has at least two primary amine groups.

11. The composition of claim 1, comprising a gelling agent, wherein the gelling agent comprises at least one of:
a calcium chelating agent;
a calcium precipitating agent;
a pH buffer;
an agent reactive with hydroxide; and
an acid generating agent,
wherein the gelling agent promotes formation of a gel comprising the maleic anhydride copolymer and the aminosilane crosslinker in contact with set cement.

12. The composition of claim 1, comprising a gel time control agent, wherein the gel time control agent comprises at least one of:
a salt that yields a basic solution when dissolved in water;
a salt that yields an acidic solution when dissolved in water;
an uncharged organic molecule that yields a basic solution when dissolved in water;
an uncharged organic molecule that yields an acidic solution when dissolved in water; and
a pH buffer,
wherein the gel time control agent accelerates or retards formation of a gel comprising the maleic anhydride copolymer and the aminosilane crosslinker in the absence of set cement.

13. A method of treating a subterranean formation, the method comprising:
providing to a subterranean formation a composition comprising:
a maleic anhydride copolymer comprising:
first repeat units I and II: 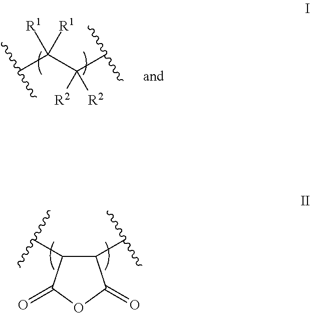
wherein each R¹ is independently selected from the group consisting of —H, —O(C₁-C₅)alkyl, and —(C₁-C₅)alkyl, and each R² is independently selected from the group consisting of —H, —O(C₁-C₅)alkyl, and —(C₁-C₅)alkyl; and
at least one second repeat unit selected from the group consisting of repeat units III and IV: 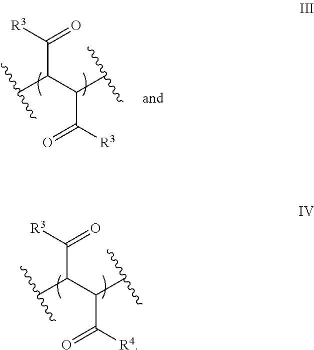
wherein each R³ is independently selected from the group consisting of —OH and —O⁻M¹, each M¹ is independently selected from the group consisting of an alkali metal, an alkaline earth metal, an ammonium ion, and a quaternary ammonium ion, and each R⁴ is independently selected from the group consisting of —NH₂ and —OM¹; and
an aminosilane crosslinker having a single primary amine group; and
crosslinking the maleic anhydride copolymer with the aminosilane crosslinker to form a sealant.

14. The method of claim 13, wherein crosslinking the maleic anhydride copolymer with the aminosilane crosslinker to form the sealant occurs near a casing, a casing-casing annulus, a tubing-casing annulus, or a casing-formation annulus.

15. The method of claim 13, wherein crosslinking the maleic anhydride copolymer with the aminosilane crosslinker to form the sealant occurs in a crack or microannulus of a pipe.

16. The method of claim 13, wherein crosslinking the maleic anhydride copolymer with the aminosilane crosslinker to form the sealant prevents or retards undesired loss or flow of wellbore fluid into the formation or of formation fluids into the wellbore.

17. The method of claim 13, comprising forming siloxane bonds between the aminosilane crosslinker and a siliceous material in contact with the composition.

18. The method of claim 13, wherein the composition comprises a gel time control agent, and crosslinking the maleic anhydride copolymer with the aminosilane crosslinker to form the sealant occurs in the absence of set cement.

19. The method of claim 13, wherein the composition comprises a gelling agent, and crosslinking the maleic anhydride copolymer with the aminosilane crosslinker to form the sealant occurs in the presence of set cement.

20. The method of claim 13, wherein the aminosilane crosslinker has 0, 1, or 2 secondary amine groups.

21. The method of claim 13, wherein the composition comprises a polyamine crosslinker having at least two primary amine groups.
